(19) United States
(12) Patent Application Publication
(10) Pub. No.: US 2014/0305774 A1
(43) Pub. Date: Oct. 16, 2014

(54) CONVEYOR DISABLER AND RELATED METHODS

(71) Applicant: SPAN TECH LLC, Glasgow, KY (US)

(72) Inventors: James L. Layne, Bowling Green, KY (US); Lewis W. Ward, Glasgow, KY (US); Stephen C. Fye, Glasgow, KY (US); Brian Keith Thomas, Glasgow, KY (US); Ervin Puskar, Franklin, TN (US)

(21) Appl. No.: 14/358,586

(22) PCT Filed: Nov. 15, 2012
(86) PCT No.: PCT/US12/65234

§ 371 Date: May 15, 2014

Related U.S. Application Data
(60) Provisional application No. 61/559,814, filed on Nov. 15, 2011.
(60) Provisional application No. 61/569,414, filed on Dec. 12, 2011.

(51) Int. Cl. B65G 23/24; B65G 15/30

(52) U.S. Cl. CPC B65G 23/24; B65G 15/30
USPC 198/832

(57) ABSTRACT

In one aspect, an apparatus is for use with a driven conveyor comprising a modular link belt including a plurality of outer links along a lateral side of the conveyor. A follower is adapted for engaging the outer side links of the conveyor belt, said follower including a normal position to a disabling position. The following is follower adapted for disabling the drive in the disabling position, such as by actuating a switch.

The disclosures of U.S. Provisional Patent App. Ser. Nos. 61/569,414 and 61/559,814 are incorporated herein by reference.

### FIELD

This disclosure relates generally to the conveying arts and, more particularly, to a conveyor disabler and related methods.

### BACKGROUND

Modular link conveyors have typically been driven by a plurality of laterally spaced, gang driven sprocket, typically located at the transition of the conveyor from the forward to the return run. Recently, another manner of driving such a conveyor has been introduced, namely driving via one or more sprockets positioned alongside a lateral side of the conveyor, as described in PCT Patent Application Serial No. PCT/US2011/036397, the disclosure of which is incorporated herein by reference. Such a side-driven conveyor offers many advantages, including the potential elimination of discontinuous conveyors wherein objects must be transferred from the trailing end of one conveyor to the leading end of another, the elimination of catenaries adjacent a sprocket, and improving the transfer of items along a curved, spiral, or helical path.

While these drive arrangements offer many advantages, they are not without limits. In any of the above drive arrangements, a break in the conveying chain or an irregularity such as a foreign object can cause the drive to improperly interact with the chain. This can result in the drive damaging significant portions of the chain itself, or damage to the drive sprocket.

Accordingly, there is a need for an improvement to the drive arrangement which accounts for the above potential results of an irregularity between the drive and the conveying chain.

### SUMMARY

An apparatus for use with a driven conveyor comprising a modular link belt including a plurality of outer links along a lateral side of the conveyor comprises a disabler for disabling the driving of the conveyor upon detecting an irregularity in connection with the outer side links.

In one embodiment, the disabler may comprise a follower adapted for engaging the outer side links of the conveyor belt. The follower includes a first position and a second position. The follower is arranged for disabling the drive in the second position.

In some embodiments, the follower comprises a sprocket having a lateral face oriented generally parallel to a plane of a conveying surface of the conveyor belt. The follower may be pivotally mounted for movement between the first and second positions. For example, the follower may be pivotally mounted to a shaft. The follower may also be arranged for contacting an interior surface of the outer side links.

In some embodiments, a switch is provided for disabling the driving of the conveyor in response to the second position of the follower. A guard may also be provided for guarding the follower. The guard may substantially surround the follower.

The apparatus may further include a drive for driving the conveyor. The drive may support the follower, and may include a first sprocket and the follower includes a second sprocket. The first and second sprockets may rotate about generally parallel axes of rotation (e.g., vertical axes).

An apparatus may also comprise a modular link conveyor including a drive for driving the conveyor in a conveying direction, said drive including a drive sprocket for engaging a surface of the links of the conveyor. A follower may be adapted for engaging the surface of the links, said follower capable of moving from a normal position to a disabling position in a direction generally transverse to the conveying direction. A switch may be provided for disabling the driving of the conveyor when the follower moves to the disabling position. In one embodiment, an interior of one of the links includes the surface.

Additionally, an apparatus be provided for use with a modular link conveyor adapted for conveying articles in a conveying direction. The apparatus may comprise a drive contacting at least one link of the conveyor, and a follower contacting the at least one link immediately before the link engaging the driver. The follower is adapted for moving from a normal position to a disabling position. A switch may be provided for disabling the drive when the follower is in the disabling position.

In one embodiment, the follower may be positioned from the drive a distance less than or equal to a length of two links of the conveyor in the conveying direction. In another embodiment, the follower is positioned from the drive a distance less than or equal to a length of five links of the conveyor in the conveying direction.

The follower may be supported by the drive. The drive may include a drive sprocket and an idler sprocket. The follower may engage an interior surface of the link.

An apparatus may also be provided for use with a conveyor adapted for conveying articles in a conveying direction, and including a drive for driving the conveyor in an endless loop including a forward run and a return run. The apparatus includes a first follower for engaging the conveyor along the forward run, the first follower having a normal position to a disabling position, and a second follower for engaging the conveyor along the return run, the second follower having a normal position to a disabling position. The drive may be disabled in the disabling position of the first or second follower.

In some embodiments, the first follower is positioned for rotation in plane above the first follower. The first follower may be rotatable about a first axis and the second follower rotatable about a second axis, wherein the first axis and second axis are spaced apart in the conveying direction. A switch may also be provided for disabling the drive when the first or second follower is in the disabling position.

A spiral conveyor may include any apparatus described above. For example, a further apparatus for conveying objects may include a conveyor adapted for moving along a spiral path, a drive for driving the conveyor along the spiral path, and a follower for engaging an outer surface of the conveyor along the spiral path. The follower may be adapted for moving from a normal position to a disabling position, and further including a switch for disabling the drive when the first or second follower moves to the disabling position.

A further apparatus may be provided for use with a modular link conveyor including a plurality of outer side links and driven by a drive. The apparatus comprises drive sprocket for rotating about a first, generally vertical axis of rotation, and a follower sprocket for rotating about a second axis generally parallel to the first axis of rotation.

In some embodiments, the drive sprocket is arranged for engaging the outer side links. In some embodiments, the follower sprocket is arranged for engaging the outer side links. The follower sprocket may be positioned downstream of the drive sprocket in the conveying direction.

The apparatus may include a plurality of drive sprockets for rotating about a first, generally vertical axis of rotation and a plurality of follower sprockets for rotating about a second axis generally parallel to the first axis of rotation. The follower sprocket may include a normal position and a disabling position, and further a switch may be provided for disabling the drive in the disabling position of the follower. The switch may comprise a proximity switch.

A method for conveying objects using a conveyor belt comprising outer side links and driven by a drive. The method comprises engaging a follower with the outer side links of the conveyor belt, said follower including a normal position and a disabling position. The method further comprises disabling the drive in the disabling position.

The engaging step may comprise engaging an interior surface of the outer side links. The disabling step may comprise actuating a switch controlling the driving of the drive. The method may further include the step of driving the conveyor belt along a linear path, or along a spiral path, or both simultaneously at different locations. The engaging step may comprise engaging the outer side links along a forward run of the conveyor belt, engaging the outer side links along a return run of the conveyor belt, or both. The method may further include a first sprocket for engaging the forward run and a second sprocket for engaging the return run.

A method of operating a driven conveyor including a drive surface, comprising adjusting the driving of the conveyor upon detecting an abnormal condition in a drive surface of the conveyor. The method may further include the step of engaging a drive surface of the conveyor with a follower capable of assuming a disabling condition corresponding to the abnormal condition, and then adjusting the driving of the conveyor in the disabling condition. The adjusting step may comprise halting the driving of the conveyor. The method may further include the step of engaging the drive surface with a drive sprocket.

An apparatus, comprises a conveyor including a drive surface and means for adjusting the driving of the conveyor upon detecting an abnormal condition in a drive surface of the conveyor. The means for adjusting comprises a follower for engaging the drive surface positioned upstream of a driver for engaging the drive surface, and a switch for halting the driving of the conveyor by the driver based on the position of the follower.

### BRIEF DESCRIPTION OF THE DRAWING FIGURES

FIGS. 1 and 2 are schematic illustrations of certain aspects of the disclosure;

FIGS. 3 and 4 are schematic illustrations of particular embodiments;

FIG. 5 is a partially cutaway perspective view of a spiral conveyor including a disabler;

FIG. 6 is a top view of the FIG. 5 arrangement;

FIG. 7 is a perspective view of a linear conveyor including the disabler:

FIG. 8 is a top cutaway view of the FIG. 7 arrangement;

FIG. 9 is a side view of a linear conveyor including drive and idler sprockets at opposed ends;

FIG. 10 is a side view of a further embodiment;

FIG. 11 is a side view of still a further embodiment;

FIG. 12 is a perspective view of yet a further embodiment;

FIG. 13 is a top view of the FIG. 12 embodiment; and

FIG. 14 is an enlarged, partially cutaway view of the FIG. 12 embodiment.

### DETAILED DESCRIPTION

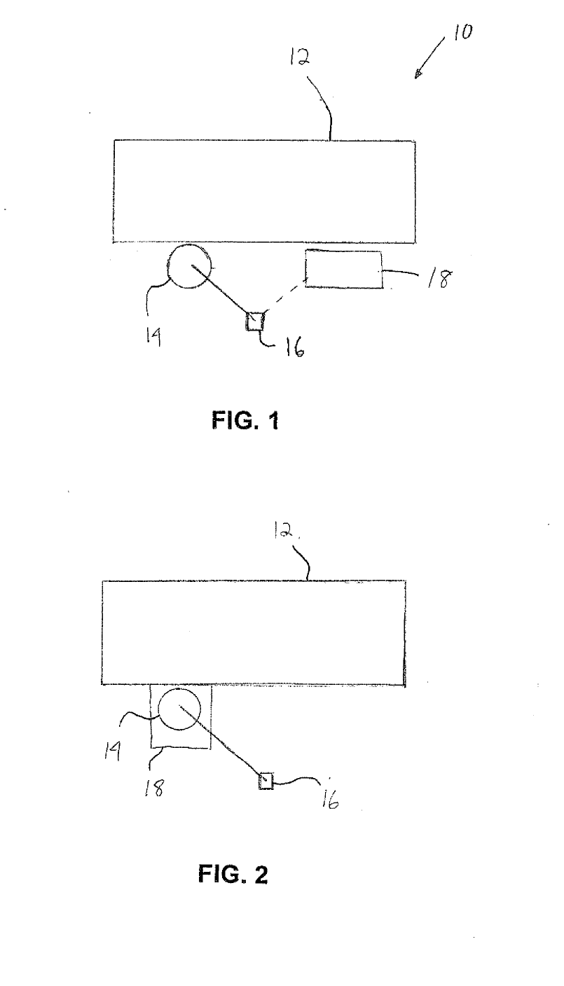

With reference to FIGS. 1 and 2, this disclosure relates to a system 10 including a conveyor 12 for conveying objections, such as by way of a belt or chain. The conveyor 12 is associated with a disabler, which may comprise a follower 14 having a normal and a disabling condition. In operation, the follower 14 may engage the conveyor 12 in a manner that permits it to assume the disabling condition upon the occurrence of a particular event, such as when an abnormality in the conveyor 12 causes the disabling condition.

In such case, the follower 14 may be adapted to provide for the disabling of the conveyor 12 in the disabling condition. For example, the follower 14 may actuate a switch 16, which in turn associates with a drive 18, as illustrated in the schematic diagram of FIG. 1. When the follower 14 is in the disabling condition, the switch 16 associated with the follower 14 disables the driving of the conveyor 12 in an effort to prevent any concomitant damage and allow for an inspection and possible rectification of the situation. The follower 14 may be provided upstream along the path of the conveyor 12 relative to the drive 18. Consequently, the conveyor 12 interacts with the follower 14 prior to interacting with the drive 18. As shown in FIG. 2 and outlined in more detail below, the follower 12 may be supported by the drive 18.

An optional biasing means (not pictured) may be present to urge the follower 14 into contact with the conveyor under normal operating conditions, while allowing movement to the disabling condition in the event of a conveyor irregularity. The biasing means may be in the form of a spring, hydraulic cylinder, resilient flexible material, or any other structure for urging contact between the follower and the conveyor.

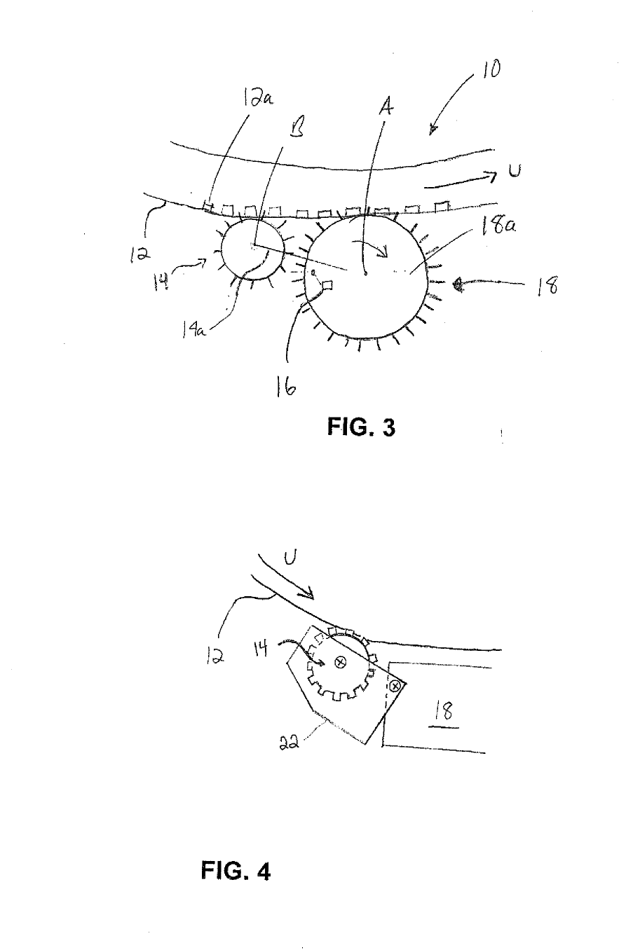

Reference is now made to FIG. 3, which depicts one particular embodiment of the system 10 including a conveyor 12 and a disabler. The conveyor 12 may comprise a modular link conveyor chain comprised of a plurality of interconnected links, including special side links 12a having outer engagement surfaces for engaging the teeth of the drive sprocket 18a (such as along a depending arm; see, e.g., U.S. Pat. Nos. 4,953,693 and 5,031,757, the disclosures of which are incorporated herein by reference). The conveyor 12 may travel along an endless path in a straight or curved configuration, as well as in any other conveying arrangement as necessitated by operational conditions.

A drive 18 is also provided for driving the conveyor 12. In this embodiment, the drive 18 includes a drive sprocket 18a for driving the conveyor 12 along a forward run U. The drive sprocket 18a as shown is mounted with its major plane generally parallel to the conveying surface. In other words, the drive sprocket 18a rotates about a generally vertical axis A when the direction of travel and thus the conveying surface are aligned with a horizontal or otherwise non-vertical plane.

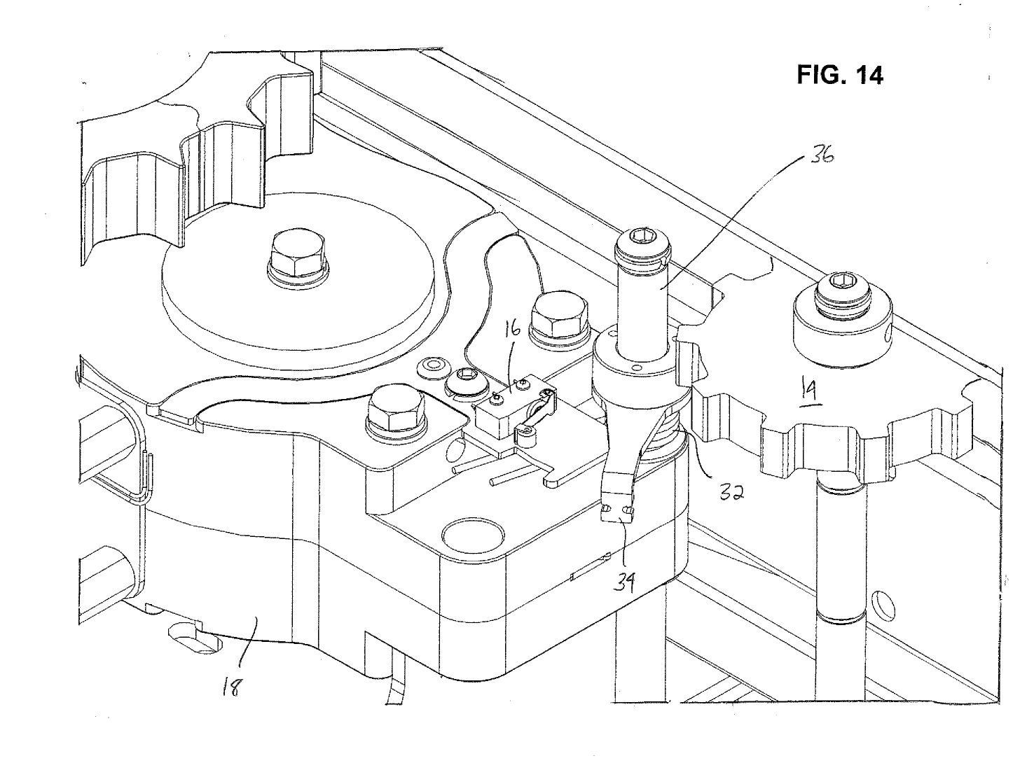

In this arrangement, a follower 14 is also arranged to contact the conveyor 12 as it is driven by the drive 18. This contact may also be with the outer side links 12a of the conveyor 12. The follower 14 may comprise a sprocket 14a mounted for rotation about a vertical axis B generally parallel to the axis A of the drive sprocket 16a. In any case, the follower 14 may be mounted for moving from a first position close to the conveyor 12 to a second position farther away from the conveyor. In the embodiment using the sprocket 14a, this may be achieved by pivotally mounting a support, such as a vertically extending idler shaft, to a stationary support structure (such as the drive 16). A biasing means, such as a spring, may urge the follower 14 to the first position (see FIG. 14).

A switch 16 may be associated with the follower 14 and, as noted above, also the drive 18. The switch 16 may be arranged for responding to movement of the follower 14 from the first position to the second position, and disabling the drive 16 as a consequence. This detection may be achieved by detecting the position of the follower 14 relative to a fixed location, such as by using a proximity switch (magnetic, optical, etc.) or the like. A limit as to the relative movement may be provided to determine whether the second position has been reached, and may be pre-determined as desired based on the particular arrangement (including to take into account any chatter or vibrations that may result during the normal course of the follower 14 engaging the chain of the conveyor 12).

As can be appreciated, if the conveyor 12 thus has a significant defect (such as, for example, a broken side link 12a) that would cause the follower 14 to move to the second position, such would trigger the disabling of the drive 18. This would advantageously prevent the defect from harming the drive 18 or otherwise allowing the operation of the conveyor 12 to continue in a compromised condition. Consequently, a potentially catastrophic failure may be avoided.

Movement of the follower 14 to the second, disabling condition thus has the potential to disable the conveyor operation. For this reason, it is preferable to protect against any undesired external influence that would cause accidental triggering. In one embodiment, as shown in FIG. 4, this may be achieved using a guard 22 to prevent foreign objects from interfering with the follower 14, which is shown as sprocket 14a. The guard 22 may be mounted to and substantially surround the sprocket 14a, and may also be connected to the drive 18. Indeed, in the situation where the guard 22 is connected directly to the follower 14, it is the guard 22 that could associate with the switch 16 and disable the drive 12.

In an alternative embodiment, a trigger 34 may be used to activate the switch 16 for disabling the drive, as perhaps best illustrated in FIG. 14. Guard 22 may be mounted to and substantially surround the sprocket 14a, and may be connected to the drive 18. The guard 22 and sprocket 14a may pivot in relation to the drive, such as via pivot 36. In this embodiment the trigger 34 pivots in coordination with the follower 14. Trigger 34 may be connected to pivot 36 to facilitate this coordinated pivot motion. Biasing means such as spring 32 may contact the trigger 34, urging the follower 14 in contact with the conveyor 12. In the event of a conveyor irregularity causing the follower 14 to move from the normal condition to the disabling condition, trigger 34 is forced into contact with switch 16, thereby disabling the conveyor drive. As should be appreciated, the trigger 34 is shown spaced relatively far apart from the switch 16, but may be positioned closer to allow for the detection of minor defects in the chain as the result of the movement of the follower 14 and the associated guard 22.

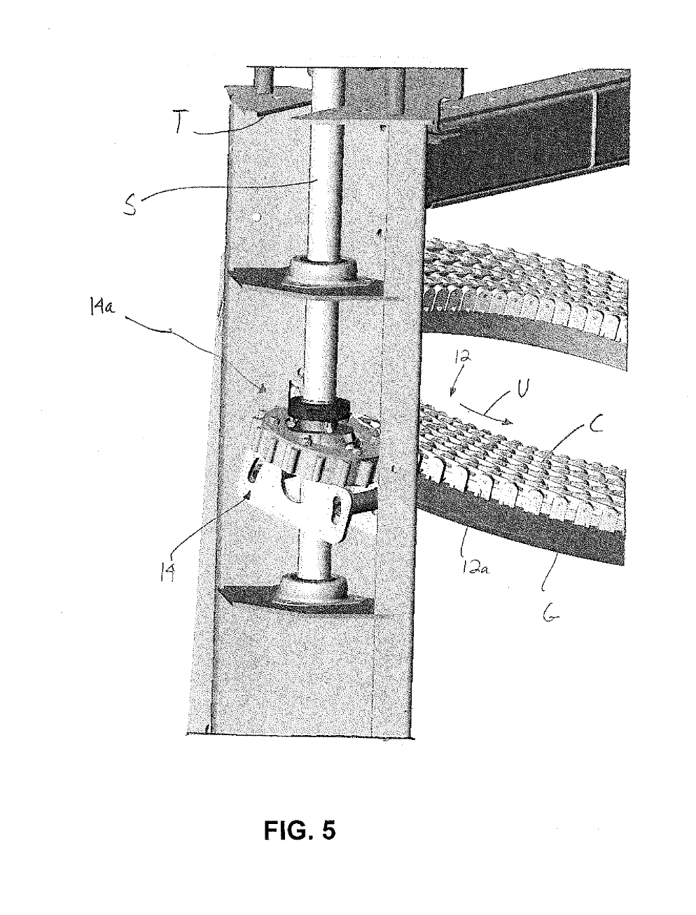

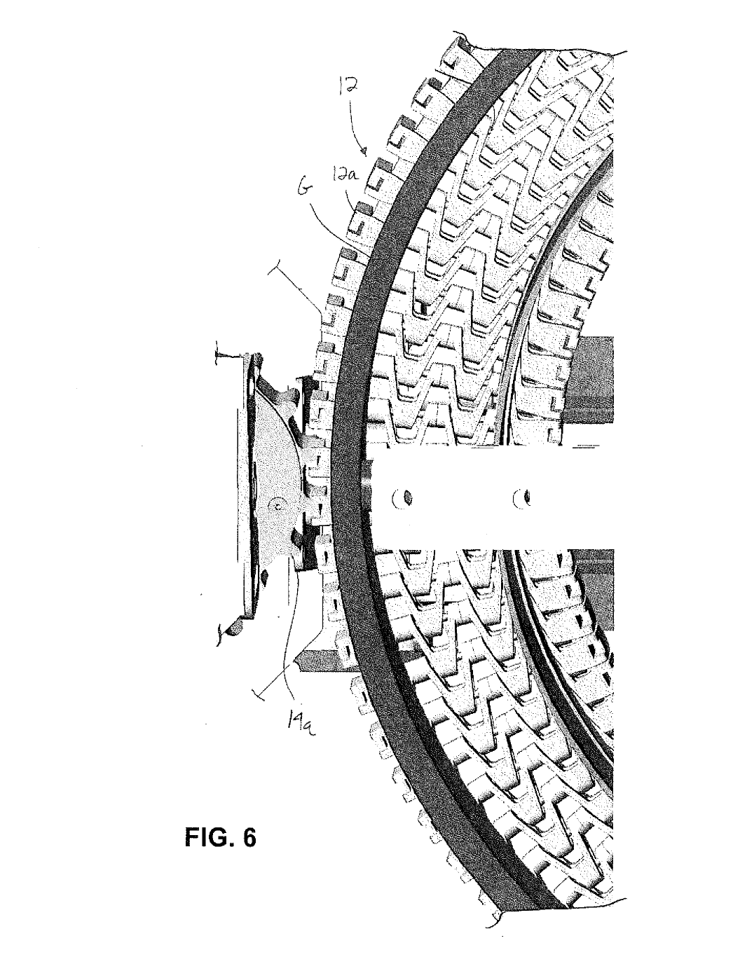

As noted above, these arrangements can be used on linear conveyors, but may also be used on other arrangements. Thus, for example, FIGS. 5-6 illustrate the application of the follower 14, such as in the form of a sprocket 14a, to a conveyor 12 arranged for following a spiral path. The drive (not shown) may be positioned completely separate from the follower 14, and may be downstream, as noted above. The sprocket 14a may be mounted to a shaft S in a manner that allows for pivoting movement to align the driving surfaces of the teeth with the engagement surfaces of the links (and a constant velocity joint may be used for this purpose, as described in the above-referenced international patent application), as well as for movement between the first and second positions (note slot T for receiving the upper portion of shaft S).

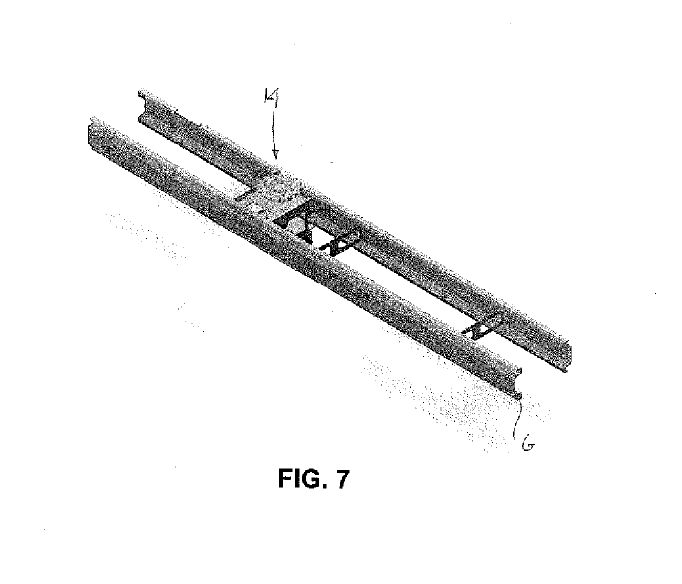

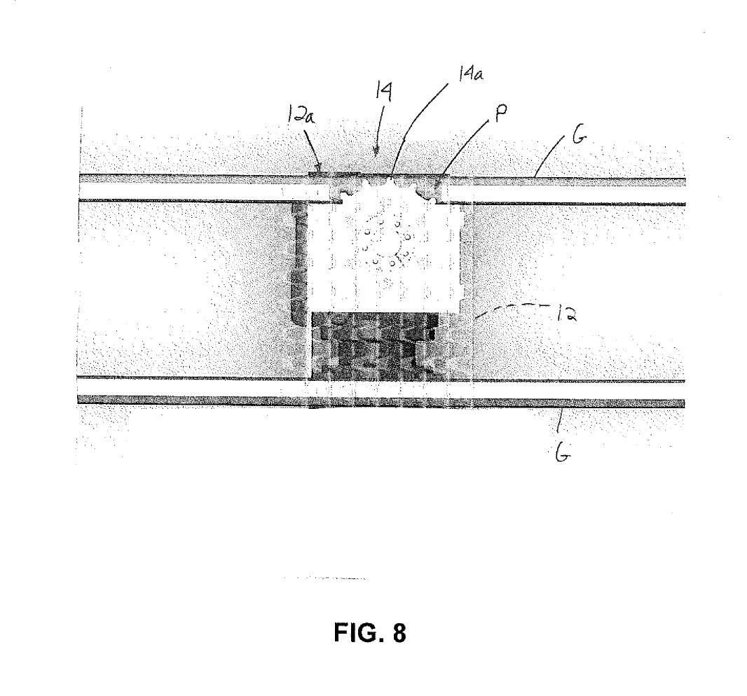

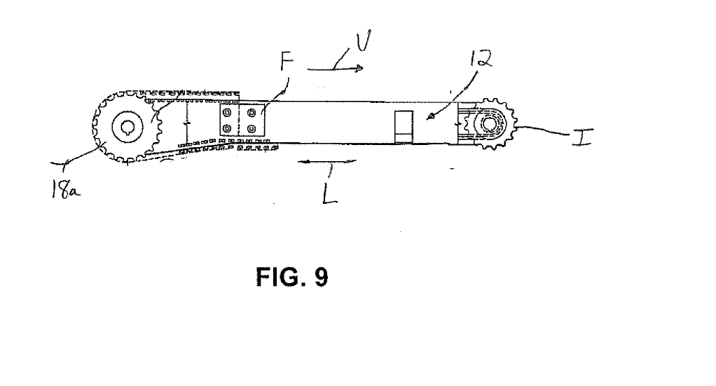

FIGS. 7-8 illustrate a follower 14 arranged so as to engage an internal surface of side links 12a of conveyor 12. In such an arrangement, the conveyor 12n may engage a guide rail G for maintaining a designated path of travel, which may include a gap P for allowing the follower sprocket 14a to engage the inside surface of the side links 12a (such as along the depending arm). The drive (not shown) may be powered by a motor, and may be positioned just downstream of the follower 14, and arranged in a manner so as to also engage the internal surface of the side links 12a. As shown in FIG. 9, the drive may also be the conventional arrangement in which a drive sprocket 18a and idler sprocket I are mounted at opposed ends of a frame F of the endless conveyor 12 for rotation about an axis transverse to the conveying direction and the vertical direction.

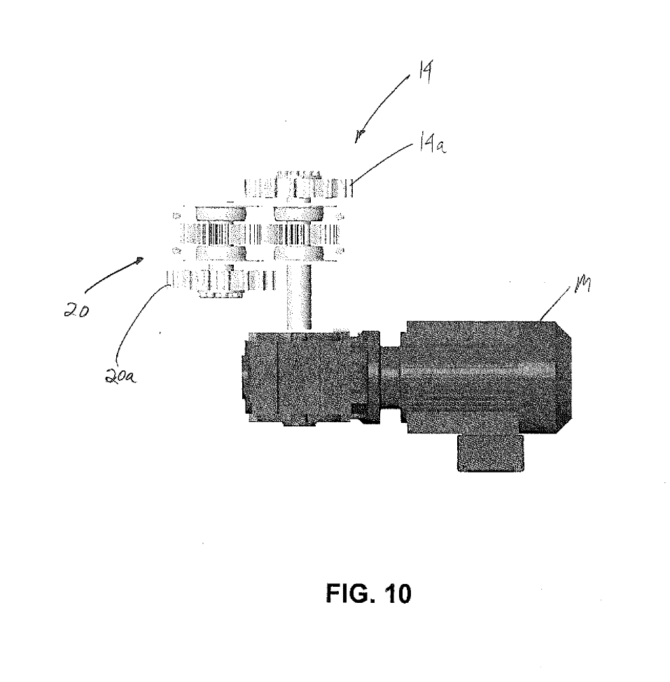

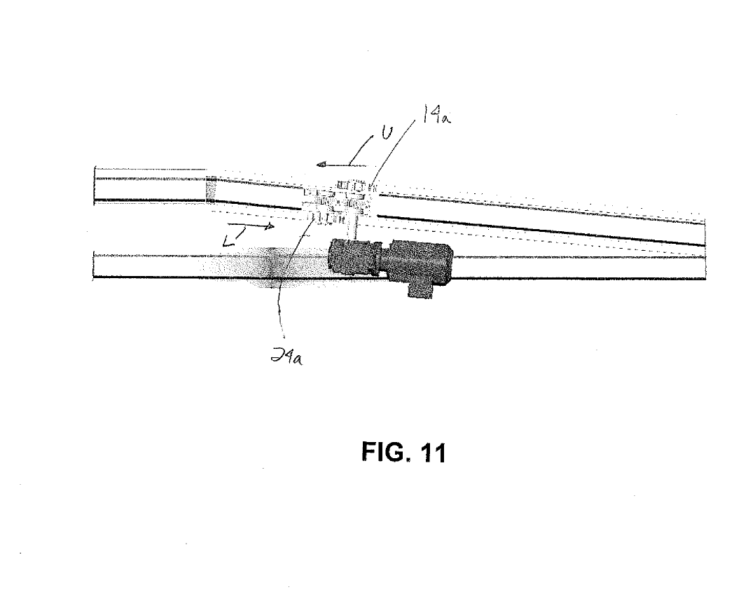

FIGS. 10-11 depict yet another embodiment for use which is used in connection with a conveyor 12 which moves in an endless loop with an upper forward path U and a lower return path L. A first follower 14 including a sprocket 14a is positioned for the upper run U, while a second follower 20 including a second sprocket 20a is positioned along the lower run L. In the case of a single drive (not shown) associated with motor M, the switch (not shown) may associate with both followers 14, 20 to cause a cutoff when either moves to the second or disabled condition.

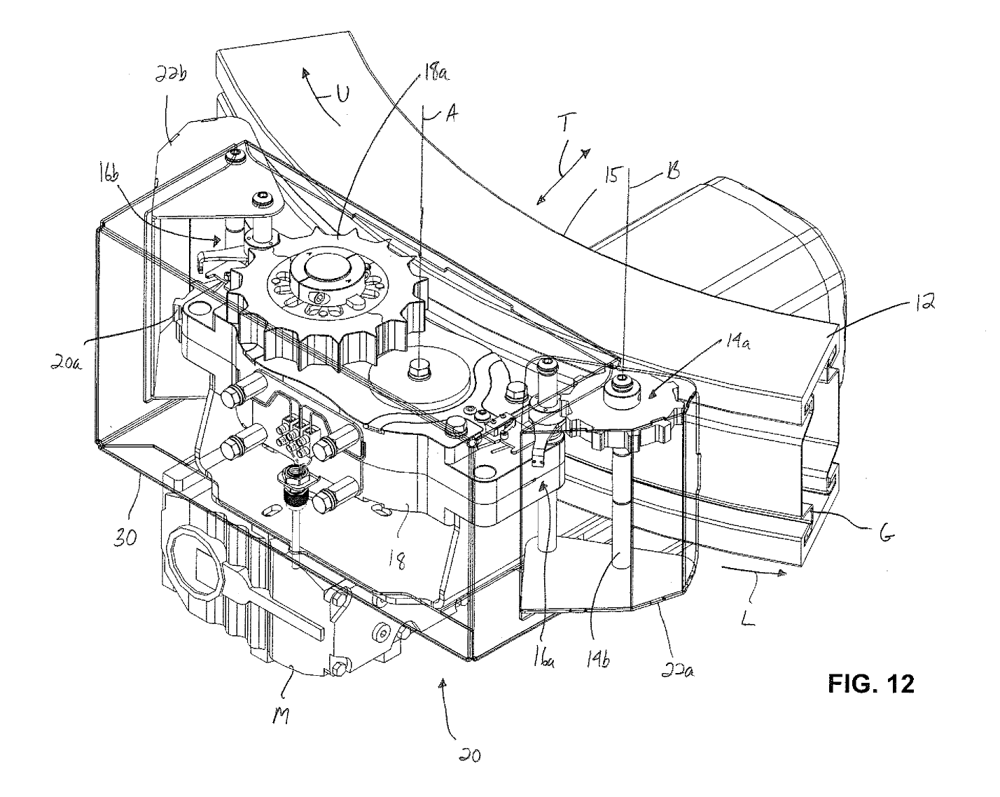

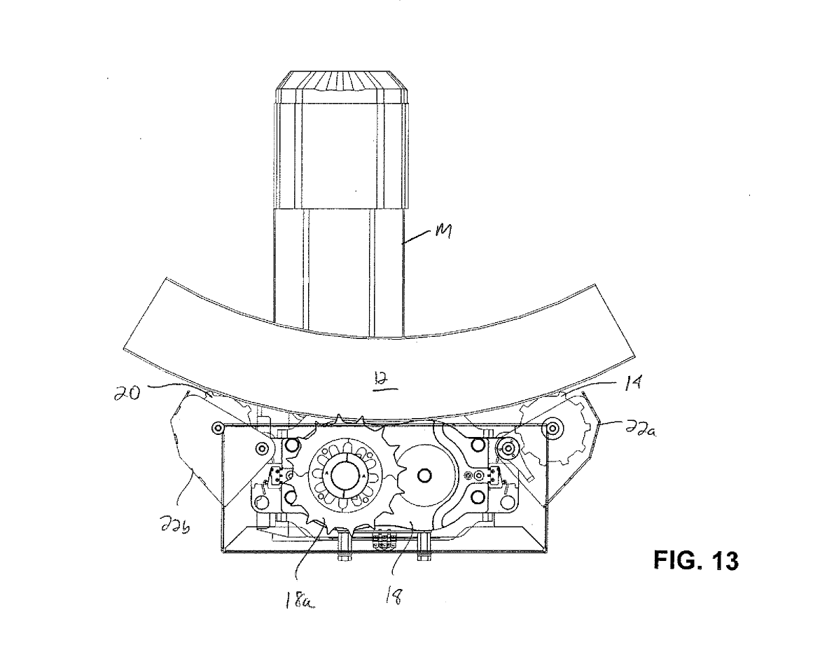

A particular embodiment is shown in FIGS. 12-14. The drive 18 includes first and second drive sprockets 18a, 18b, which may be gang driven by a motor in opposite directions for driving the upper U and lower L runs, respectively. A first follower 14 in the form of a first sprocket 14a mounted to a rotatable shaft 14b forming the vertical axis B is mounted for transverse movement (note direction T) adjacent the conveyor 12, and preferably upstream of the drive sprocket 18a, while a second follower 20 including a sprocket 20a is mounted for transverse movement upstream of the drive sprocket 18b for the return run L. Both followers 14, 20 are associated with switches 16a, 16b, such that movement to the corresponding followers 14, 20 from the first position to the second position will adjust the drive, such as by cutting power to motor M to disable it. Both followers 14, 20 may include guards 22a, 22b, and the entire assembly may form part of a single drive unit 30 including a support for engaging the guide rail G.

While it may be possible to form the follower 14 (or 20) and drive 18 as a unit, it is possible to form the follower as a separate device that simply communicates with the switch 16 in an indirect fashion. This would advantageously allow for easy and inexpensive retrofitting onto existing drive arrangements. The communication may be direct, as by way of mechanical or electrical link, but could also be through indirect means, such as a wireless radiofrequency signal generated when the movement of the follower 14 is such that an undesired condition is detected.

The conveyor 12 may be side-flexing, and arranged such that the links of adjacent rows may move toward or away from each other as the result of longitudinal compression. In this case, the use of a sprocket 14a as the follower 14 in advance of the drive sprocket 18a has the advantage of regulating the spacing of the links to a generally uniform condition. This helps to ensure that the engagement faces of the links of the conveyor are presented in a generally uniform manner to the drive sprocket 18a, and thus helps to enhance the efficiency and reduce stress and wear on the links as the result of continuous engagement in a sub-optimal manner. However, it is also possible for the follower to take the form of a wheel having a smooth outer surface for engaging the conveyor 12, or even for the follower to take the form of a non-rotating body, such as a pivoting arm, for contacting the conveyor. The disabling position may be closer to or father away from the conveying path relative to the home position.

As noted previously, the follower 14 should be mounted upstream of the drive 18. In the case of a modular link conveyor 12, the follower 14 may be positioned an upstream distance less than a length of five links of the conveyor, as measured in the conveying direction (that is, in the direction of arrow U). However, the follower 14 could be positioned as close as two links away, especially if the links are particularly large or the rate of travel is relatively slow. Likewise, the spacing could be greater or different if dictated by the particular circumstances of the conveying operation.

The foregoing descriptions of various embodiments provide illustration of the inventive concepts. The descriptions are not intended to be exhaustive or to limit the disclosed invention to the precise form disclosed. Modifications or variations are also possible in light of the above teachings. As should be appreciated, any effort to halt the driving of the conveyor may result, at least initially, in a reduction in the driving speed, since the conveyor may continue to travel in the conveying direction even with the drive disabled. The embodiments described above were chosen to provide the best application to thereby enable one of ordinary skill in the art to utilize the inventions in various embodiments and with various modifications as are suited to the particular use contemplated. All such modifications and variations are within the scope of the invention.

1. An apparatus for use with a driven conveyor comprising a modular link belt including a plurality of outer links along a lateral side of the conveyor, comprising:
a follower adapted for engaging the outer side links of the conveyor belt, said follower including a first position and a second position, said follower adapted for disabling the drive in the second position.

2. The apparatus of claim 1, wherein the follower comprises a sprocket having a lateral face oriented generally parallel to a plane of a conveying surface of the conveyor belt.

3. The apparatus of claim 1, wherein the follower is pivotally mounted for movement between the first and second positions.

4. The apparatus of claim 1, further including a switch for disabling the driving of the conveyor in response to the second position of the follower.

5. The apparatus of claim 1, further including a guard for guarding the follower.

6. The apparatus of claim 5, wherein the guard substantially surrounds the follower.

7. (canceled)

8. The apparatus of claim 1, wherein the follower is supported by a drive for driving the conveyor.

9. The apparatus of claim 8, wherein the drive includes a first sprocket and the follower includes a second sprocket.

10. The apparatus of claim 9, wherein the first and second sprockets rotate about generally parallel axes of rotation.

11. The apparatus of claim 1, wherein the follower is pivotally mounted to a shaft.

12. The apparatus of claim 1, wherein the follower is arranged for contacting an interior surface of the outer side links.

13. An apparatus, comprising:
a modular link conveyor including a drive for driving the conveyor in a conveying direction, said drive including a drive sprocket for engaging a surface of the links of the conveyor;
a follower adapted for engaging the surface of the links, said follower capable of moving from a normal position to a disabling position in a direction generally transverse to the conveying direction; and
a switch for disabling the driving of the conveyor when the follower moves to the disabling position.

14. (canceled)

15. An apparatus for use with a modular link conveyor adapted for conveying articles in a conveying direction, comprising:
a drive contacting at least one link of the conveyor;
a follower contacting the at least one link immediately before the link engaging the driver, said follower adapted for moving from a normal position to a disabling position; and
a switch for disabling the drive when the follower is in the disabling position.

16. The apparatus of claim 15, wherein the follower is positioned from the drive a distance less than or equal to a length of two links of the conveyor in the conveying direction.

17.-20. (canceled)

21. An apparatus for use with a conveyor adapted for conveying articles in a conveying direction, and including a drive for driving the conveyor in an endless loop including a forward run and a return run, comprising:
a first follower for engaging the conveyor along the forward run, the first follower having a normal position and a disabling position; and
a second follower for engaging the conveyor along the return run, the second follower having a normal position and a disabling position,
whereby the drive is disabled in the disabling position of the first or second follower.

22.-25. (canceled)

26. An apparatus for conveying objects, comprising:
a conveyor adapted for moving along a spiral path;
a drive for driving the conveyor along the spiral path; and
a follower for engaging an outer surface of the conveyor along the spiral path.

27. The apparatus of claim 26, wherein follower is adapted for moving from a normal position to a disabling position, and further including a switch for disabling the drive when the first or second follower moves to the disabling position.

28. An apparatus for use with a modular link conveyor including a plurality of outer side links and driven by a drive, comprising:
a drive sprocket for rotating about a first, generally vertical axis of rotation; and
a follower sprocket for rotating about a second axis generally parallel to the first axis of rotation.

29.-34. (canceled)

35. A method of conveying objects using a conveyor belt comprising outer side links and driven by a drive, comprising:
engaging a follower with the outer side links of the conveyor belt, said follower including a normal position and a disabling position; and
disabling the drive in the disabling position.

36.-44. (canceled)

45. A method of operating a conveyor driven at a drive speed, said conveyor including a continuous belt or chain having a drive surface, comprising:
adjusting the drive speed of the conveyor upon detecting an irregularity in a drive surface of the continuous belt or chain.

46.-51. (canceled)
